(19) United States
(12) Patent Application Publication
(10) Pub. No.: US 2013/0340685 A1
(43) Pub. Date: Dec. 26, 2013

(54) Chew Item Enhancement For Animals

(71) Applicant: Radio Systems Corporation, Knoxville, TN (US)

(72) Inventor: Ryan Grepper, Portland, OR (US)

(73) Assignee: Radio Systems Corporation, Knoxville, TN (US)

(21) Appl. No.: 13/706,875

(22) Filed: Dec. 6, 2012

Related U.S. Application Data
(60) Provisional application No. 61/630,250, filed on Dec. 6, 2011.

(51) Int. Cl. A01K 11/00

(52) U.S. Cl. CPC A01K 15/026
USPC 119/709

(57) ABSTRACT

A chew item enhancement for animals, a chew item enhancement for animals, including an edible treat wrap having a separator provided to at least one side thereof, the edible treat wrap being formed of a self-adhering material such that when the treat wrap is removed from the separator and the treat wrap is applied to a chew item, the treat wrap adheres to the chew item to encourage the animal to chew the chew item.

### CROSS-REFERENCE TO RELATED APPLICATIONS

This application claims the benefit of U.S. Provisional Application No. 61/630,250 filed on Dec. 6, 2011.

### FIELD OF INVENTIVE CONCEPT

The present general inventive concept relates generally to pet treats and chews, and, more particularly, to a chew item enhancement which can be applied to pet chew items and toys to increase a pet's enjoyment and interaction with the pet chew items and toys, and which may be used to enclose pills or other medication to encourage a pet or other animal to chew and/or swallow the medication.

### BACKGROUND

Various types of pet treats and chews have been popular with pet owners for quite some time. Such treats and chews may be provided as a reward for desired behavior, to promote dental health and hygiene, or simply for enjoyment by the pet. Typically, pet treats and chews are made from meat and other products, in a variety of shapes and degrees of rigidity.

A typical concern shared by many pet owners, regarding conventional pet treats and chews, is the desire to give their pets a treat that is pleasant tasting and nutritious, and that also will entertain their pets for a reasonable length of time. Unfortunately many conventional treats that are the best tasting are quickly eaten by pets. Another problem with conventional pet treats and chews is that pet treats and chews that are made of a tougher material, which is designed to last longer, are often not eaten completely at a given time, and pets may become bored of the treat or chew before it is entirely consumed. Yet another problem with conventional pet treats and chews is that many plastic chew toys which are designed to not be consumed, but rather to simply be chewed to improve dental and gum health, are not played with for as long as the owner would like, and therefore much of the dental and gum health benefits may not be gained. Thus, it would be better for the pets overall health if such chew toys could be enhanced so that pets would chew on them longer.

Another problem encountered by pet owners is the difficulty in giving pets and animals medication and vitamins, such as pills, because the pets and animals are often unwilling to eat them. While there have been a number of ways pet and animal owners have attempted to solve this problem, there have been many difficulties in developing a system that addresses the numerous issues involved. One method of “pilling” animals has been hiding the pill in meats or cheeses. This method is problematic because often the meat and cheese can be eaten and the pill spit out. Another problem is that it is messy for the owner to insert the pill. Yet another problem is that the meat and cheeses are not recommended for many pets and animals because of high calories involved, especially for the high percentage of overweight pets in need of medication and vitamins.

One conventional method of giving pills to pets is to use edible pockets, wherein the pill is inserted into a soft meat based treat with a hollow center. The open end is then pinched to seal the pill inside, and the resulting combination is fed to the pet or animal. One problem with this method is that the meat based treat is not very healthy for many pets and animals, especially when many medications and vitamins are required. Another problem with this method is that multiple types of edible pocket products must be purchased depending on whether the pill is a capsule or tablet, small or large size, or for cats or dogs. Yet another problem with this method is that while the use of edible pockets may be easier and less messy than hiding the pill in meat or cheese, the cost of each treat is substantial. Many pet and animal owners are not able to afford this simpler method of “pilling,” and end up not giving their pets and animals the medication they require due to frustration and cost.

Thus, a chew item enhancement that would increase a pet's enjoyment and interaction with chew items and toys, while diminishing some of the problems discussed above, is desired. Also desirable is a product that would allow pet and animal owners to easily, inexpensively, and effectively disguise pills of all sizes to be administered to their pets and animals.

### BRIEF SUMMARY

The present general inventive concept, in some of its embodiments, provides a chew item enhancement in the form of a treat wrap which adheres to itself and other items, and which may be applied to various chew items or toys to enhance a pet or other animal's pleasure and time spent with the chew item or toy.

The treat wrap may also be used to enclose pills, capsules, and the like such that medication, vitamins, etc., may be provided to the pet or other animal in a convenient manner that is pleasing to the pet other animal.

Additional aspects and advantages of the present general inventive concept will be set forth in part in the description which follows, and, in part, will be obvious from the description, or may be learned by practice of the present general inventive concept.

Example embodiments of the present general inventive concept can be achieved by providing a chew item enhancement for animals, including an edible treat wrap having a separator provided to at least one side thereof, the edible treat wrap being formed of a self-adhering material such that when the treat wrap is removed from the separator and the treat wrap is applied to a chew item, the treat wrap adheres to the chew item to encourage the animal to chew the chew item.

The chew item enhancement can be rolled and provided in a dispenser. The dispenser can include an opening with a cutting tool, such that an end of the chew item enhancement extends into the opening and the rolled chew item enhancement rotates as the end is drawn through the opening to enable the cutting tool to cut the chew item enhancement to a predetermined length.

Example embodiments of the present general inventive concept can be achieved by providing a system to provide a chew item enhancement to animals, the system including an edible treat wrap having a separator provided to at least one side thereof, the edible treat wrap being formed of a self-adhering material such that when the treat wrap is removed from the separator and the treat wrap is applied to a chew item, the treat wrap adheres to the chew item to encourage the animal to chew the chew item, and a dispenser to accommodate and dispense the edible treat wrap to a user.

Example embodiments of the present general inventive concept can be achieved by providing a method of administering an ingestible item to an animal, the method including providing an edible treat wrap having a separator on at least one side thereof, the treat wrap being formed of a self-adhering material, cutting the treat wrap to a predetermined length, removing the treat wrap from the separator, placing the ingestible item proximate a first end of the treat wrap, folding a second end of the treat wrap over the ingestible item to contact the first end, pressing the first and second ends of the treat wrap together to sealably enclose the ingestible item therein, thus forming a treat wrap-ingestible item combination, and administering the combination to the mouth of the animal.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a partially unrolled treat wrap according to an example embodiment of the present general inventive concept;

FIG. 2 illustrates the treat wrap of FIG. 1 partially applied to a chew item;

FIG. 3 illustrates the chew item of FIG. 3 after application of the treat wrap according to an example embodiment of the present general inventive concept;

FIG. 4 illustrates a dispenser used to store and dispense the treat wrap according to an example embodiment of the present general inventive concept;

FIGS. 5-7 illustrate a method of using the treat wrap to administer medication according to an example embodiment of the present general inventive concept;

FIG. 8 illustrates a stack of individually sized treat wraps according to an example embodiment of the present general inventive concept;

FIG. 9 illustrates a stack of individually sized treat wraps according another example embodiment of the present general inventive concept;

FIG. 10 illustrates an individually packaged treat wrap according to an example embodiment of the present general inventive concept; and

FIG. 11 illustrates multi-packaging of the individually packaged treat wrap illustrated in FIG. 10, according to an example embodiment of the present general inventive concept.

### DETAILED DESCRIPTION

Reference will now be made to various example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The described progression of processing operations described are merely examples, however, and the sequence of operations is not limited to that set forth herein and may be changed as is known in the art, with the exception of operations necessarily occurring in a certain order. Also, description of well-known functions and constructions may be omitted for increased clarity and conciseness.

Various embodiments of the present general inventive concept provide a chew item for animals including an edible treat formed in a substantially flat and elongated shape, also referred to herein as a treat wrap, which may be used with pet chew products and toys, may aid in administering medication such as pills, or may simply be enjoyed as a treat itself. The treat wrap may be made of any edible substance, such as meats, grains, fruits, vegetables, etc., in any variety of shape, and may be formed so as to adhere to itself and be able to attach to a chew item in such a way as to conform to the shape of the chew item. The treat wrap may be wrapped around various pet products such as, for example, plastic or rubberized chew bones or toys, natural chew items such as rawhide bones or strips, etc. The chew item may be either edible or non-edible, and may be specially designed to keep the section of the chew item upon which the treat wrap is to be applied elevated off of the floor, thereby allowing the chew item to be chewed upon indoors for owners who are particular to this level of cleanliness. Various lengths of the treat wrap may also be used to enclose a pill, capsule, etc. The treat wrap is also pliable enough to form into a shape desired by the user. In various embodiments of the present general inventive concept, the treat wrap may be formed in thin flat strips, or may be an extruded string of material of any shape wherein the treat wrap can be applied to the exterior of a chew treat and adhere to itself and, in some example embodiments, the chew item.

In various embodiments of the present general inventive concept, the treat wrap is formed so as to adhere to itself, and can be provided with a non-stick or low-stick separator to enable the treat wraps to be stacked individually or rolled upon itself. For example, a backing can be provided on at least one flat side of the treat wrap to prevent the treat wrap from sticking to itself before use. In other various example embodiments, the separator can be an individual packet to enclose an individual treat wrap such that when multiple treat wraps are stacked upon one another, the treat wraps do not stick to each other. The separator can also be any other type of dividing material provided between individual strips of the treat wrap, enabling the treat wraps to be stacked or packaged together in multiple quantities, allowing the user to easily remove one treat wrap at a time. The treat wrap may be formed as a strip so that the treat wrap may be easily wrapped around, for example, chew items, toys, pills, etc. The adhering quality of the treat wrap maintains the contact of the treat wrap to the chew items, as well as a seal when wrapped around a pill or capsule. For example, the treat wrap can be wrapped around a chew item in an overlapping manner to enable the treat wrap to adhere to itself and the chew item. The pill or capsule may be any type of medication, vitamin, supplement, or similar item. Less rigid substances such as pastes or gels may be similarly wrapped and administered to the pet or other animal.

In various example embodiments, the non-stick or low-stick backing provided to at least one side of the treat wrap allows the product to be packaged without sticking to itself, and may be easily removed prior to or during application of the treat wrap to the chew item, toy, pill, capsule, etc. The treat wrap backing may be made of various materials such as plastic, friction reduced paper, or the like, or combinations of such materials. In various example embodiments, the treat wrap may be stored in a roll in order to make efficient used of storage or packaging space.

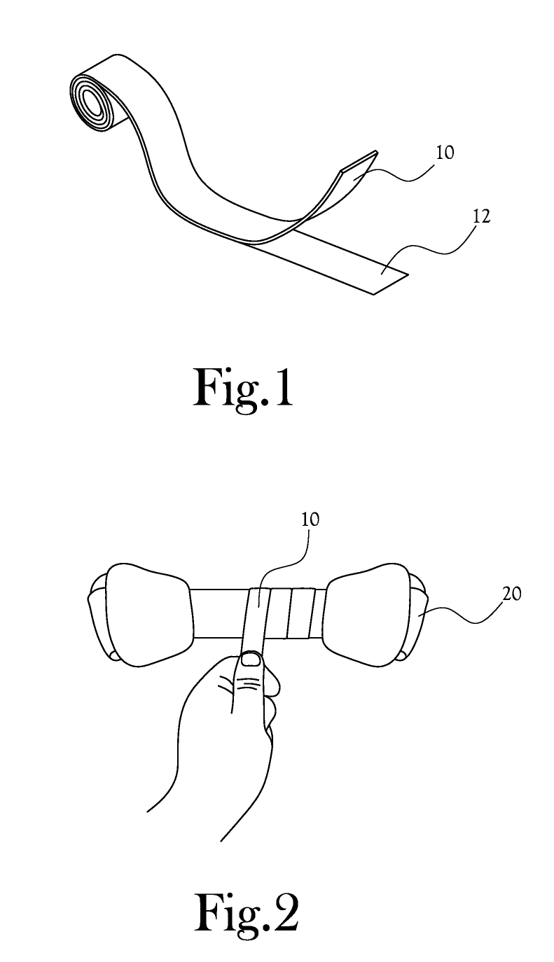

FIG. 1 illustrates a partially unrolled treat wrap according to an example embodiment of the present general inventive concept. In FIG. 1, the treat wrap 10 is shown as being separated at a distal end from a non-stick backing 12 that is provided on a side of the treat wrap 10 that faces the roll. This is simply one example embodiment of the present general inventive concept, as the non-stick backing 12 may be provided to either side of the treat wrap 10, or to both sides. The non-stick backing aids the user in applying the treat wrap 10 to a toy or chew item to be provided to a pet or other animal. For example, the user may obtain a length of the treat wrap 10 to apply to a chew toy, and begin by wrapping the treat wrap 10 around the chew toy before removing the non-stick backing 12 from the treat wrap 10.

FIG. 2 illustrates the treat wrap 10 of FIG. 1 partially applied to a chew item, which in this example is a rawhide chew bone 20. In FIG. 2 the user is wrapping the treat wrap 10 around the length of the middle of the chew bone 20, but it is apparent that the user could also apply the treat wrap 10 around the large ends of the chew bone 20. In order to simplify the drawing, the treat wrap 10 is illustrated with the non-stick backing 12 already removed. Of course, the non-stick backing 12 may remain on the chew bone 20 until the application of the treat wrap 10 is completed, and then removed before giving the chew bone 20 to the pet.

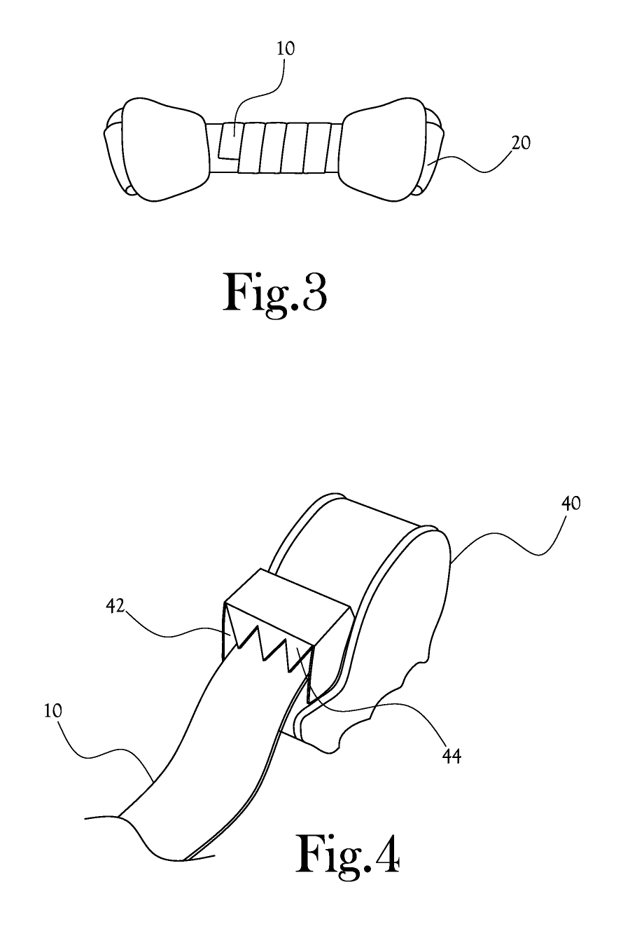

FIG. 3 illustrates the chew bone 20 of FIG. 3 after application of the treat wrap 10 according to an example embodiment of the present general inventive concept. As previously discussed, although the user has applied the treat wrap 10 to only the middle portion of the chew bone 20, the treat wrap could easily be applied to more or less surface area of the chew bone 20. Also, while the example illustrated in FIG. 3 shows a single layer of the treat wrap 10 being applied to the chew bone 20, the user may provide more layers at various locations as desired, as the treat wrap 10 will adhere to itself as well as the chew bone 20. With the treat wrap 10 applied to the chew bone 20, the pet may be encouraged to enjoy the chew bone 20 for a longer duration than the pet might have without such an enhancement, which may aid in the enjoyment of the chew bone 20, and may also be beneficial in maintaining good dental health and hygiene. As the treat wrap 10 adheres to itself, and also to the chew bone 20, the pet may need to chew and gnaw at the chew item for some time to get the entire tasty treat wrap off of the item. Also, if an edible chew item is provided with the treat wrap 10, the pet will have the increased satisfaction of a tasty outer layer added to the chew item as it is eaten, which can encourage longer interaction with the chew item. If the chew item is not edible, or is edible but not fully consumed, the pet owner can apply an additional layer of the treat wrap 10 at a later time as desired.

According to various example embodiments of the present general inventive concept, the treat wrap 10 may be provided in packaging that may be designed to aid in maintaining the freshness of the treat wrap 10. For example, the packaging may substantially enclose the treat wrap 10 to prevent or delay the drying of the treat wrap 10. Various example embodiments of such packaging may include a single serving type packaging which is opened once to remove the treat wrap 10, a rigid container with a lid which is opened to access the treat wrap 10, a re-sealable bag type packaging, a dispenser to dispense desired portions of the treat wrap 10 without substantially exposing the remaining treat wrap 10 to the outside of the dispenser, or other various types of packaging.

FIG. 4 illustrates a dispenser 40 used to store and dispense the treat wrap 10 according to an example embodiment of the present general inventive concept. The dispenser 40 is substantially round in shape to accommodate the treat wrap 10 in a rolled form, and has and opening 42 through which an outer end of the treat wrap 10 may be pulled by the user to select a desired length of the treat wrap 10. The dispenser 40 may also include a cutting tool 44 at the opening 42 which may be used to sever the desired length of the treat wrap 10. With such a dispenser 40, the user may extract a desired length of the treat wrap 40 to apply to a chew toy, or for any other use, or the exposed end of the treat wrap 10 may be applied to the chew toy and the dispenser 40 used to wrap the chew toy as the treat wrap 10 is extracted, and the treat wrap 10 may be severed at the end of the wrapping operation. As illustrated in FIG. 1, the treat wrap 10 accommodated inside the dispenser 40 may have the non-stick backing 12 provided to at least one side of the treat wrap 10, so that the treat wrap 10 does not stick to itself and inhibit removal from the dispenser 40.

According to various example embodiments of the present general inventive concept, the treat wrap 10 may also be used to enclose pet or other animal medication, such as pills, to encourage the ingestion of the pill by the animal. FIGS. 5-7 illustrate a method of using the treat wrap 10 to administer medication, in this example, a pill, according to an example embodiment of the present general inventive concept.

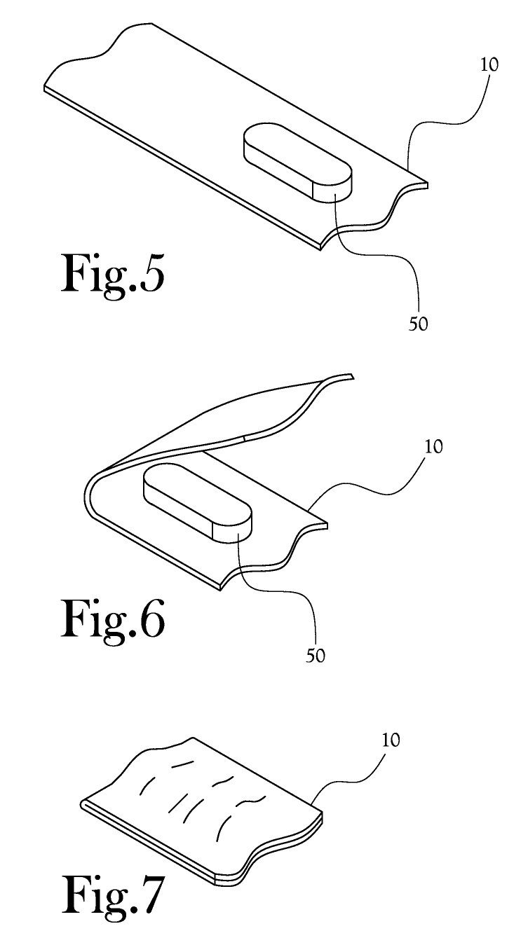

As illustrated in FIG. 5, a desired length of the treat wrap 10 may be acquired by the user to enclose the pill 50. According to various example embodiments, the length of the treat wrap 10 used to enclose the pill 50 may be taken from the dispenser 40 illustrated in FIG. 4, cut from an unpackaged roll of the treat wrap 10, pre-formed during production and sold in, for example, stacks of strips readily formed for the wrapping of pills, individually packaged strips, and so on. The non-stick or low-stick backing may be removed from the treat wrap 10 before or after enclosing the pill 50. The user may lay the pill 50 proximate to a first end of the length of the treat wrap 10, as illustrated in FIG. 5. The user may then fold a second end of the length of the treat wrap 10 over the pill 50 to meet the first end, as illustrated in FIG. 6. The user may then push the first and second ends of the length of treat wrap 10 together to form a seal, and perform the same operation at either side of the treat wrap 10, to form a fully closed enclosure of the pill 50. The enclosed pill 50 may then be given to the pet or other animal to enjoy without being aware that the pill 50 is enclosed inside.

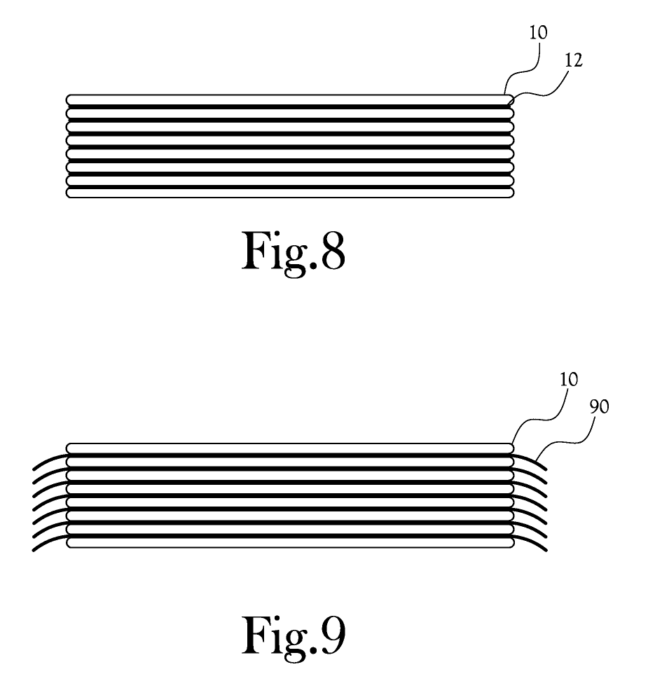

FIG. 8 illustrates a stack of individually sized treat wraps according to an example embodiment of the present general inventive concept. In the example embodiment illustrated in FIG. 8, the treat wrap 10 is provided with the non-stick or low-stick backing 12 as discussed in the description of FIG. 1, and small individually sized portions of the treat wrap 10 have been apportioned and stacked upon one another to increase the convenience of the user. The user can simply and conveniently take one of the illustrated individually sized treat wraps 10 to wrap a pill or other medication/supplement, to wrap around a chew toy, etc. Several of the treat wraps 10 may be conveniently layered upon one another on a toy or other chew item. The stack of treat wraps may be packaged in any number of ways, such as, for example, a re-sealable bag, a rigid container with a screw-on or snap-on lid, and so on.

FIG. 9 illustrates a stack of individually sized treat wraps according another example embodiment of the present general inventive concept. In the example embodiment illustrated in FIG. 9, a stack of individually sized portions of the treat wrap 10 are separated by a plurality of separators 90 to separate the individual treat wraps 10 from one another. As with the other various example embodiments, the stack illustrated in FIG. 9 may be packaged in any number of ways, such as, for example, a re-sealable bag, a box, a rigid container with a screw-on or snap-on lid, or any other packaging chosen with sound engineering judgment.

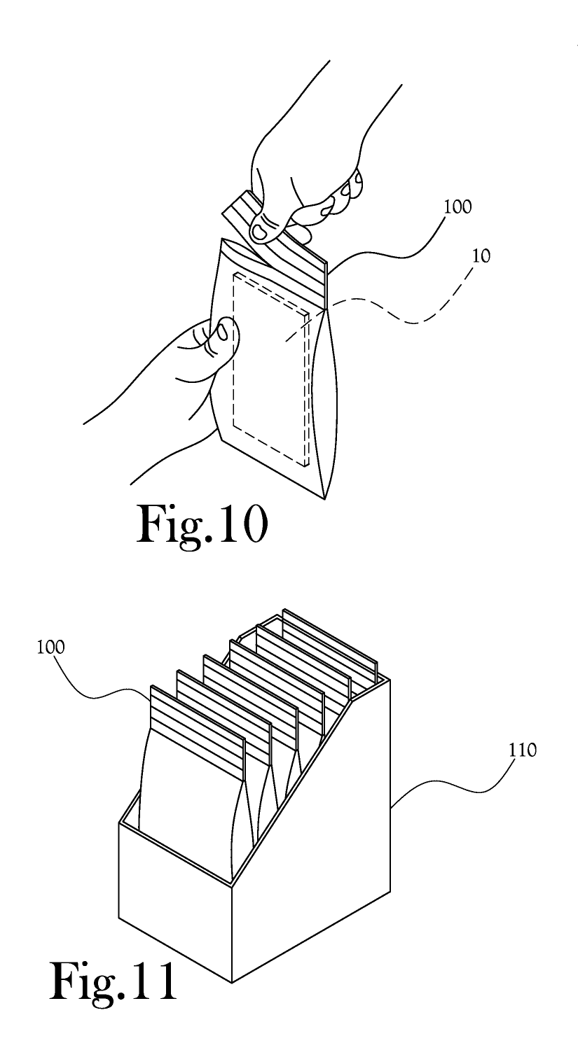

FIG. 10 illustrates an individually packaged treat wrap according to an example embodiment of the present general inventive concept. In the example embodiment illustrated in FIG. 10, the separator packaging for the treat wrap 10 includes an individual packaging 100 such as cellophane or the like. As illustrated in FIG. 10, the user may simply open the individual packaging 100 to remove the individually sized treat wrap 10 for the desired use, such as, for example, to wrap a pill or other medication/supplement, to wrap around a chew toy, etc.

FIG. 11 illustrates multi-packaging of the individually packaged treat wrap illustrated in FIG. 10, according to an example embodiment of the present general inventive concept. In the example illustrated in FIG. 11, a plurality of the treat wraps that are respectively provided in the individual packaging 100 illustrated in FIG. 10 are provided in a multi-package 110 such as a cardboard box or the like, which can be used for storage by the user, display by a store for individual sale of the individually wrapped treat wraps, and so on. Although the multi-package 110 is illustrated as being an open box of a cutaway design in FIG. 10, any number of styles of multi-packaging may be used, such as a re-sealable bag or box, and so on.

According to various embodiments of the present general inventive concept, a chew item enhancement is provided for pets or other animals, including an edible treat wrap formed to adhere to itself and other items such that the treat wrap substantially conforms to a shape of the items, and a non-stick backing provided to at least one side of the edible layer. The treat wrap may be wrapped around various chew items to increase enjoyment and length of time spent with the chew item by the pet or other animal, and may be used to enclose pills, capsules, etc., to be administered to the pet or other animal.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A chew item enhancement for animals, comprising:
an edible treat wrap having a separator provided to at least one side thereof, the edible treat wrap being formed of a self-adhering material such that when the treat wrap is removed from the separator and the treat wrap is applied to a chew item, the treat wrap adheres to the chew item to encourage the animal to chew the chew item.

2. The chew item enhancement of claim 1, wherein the treat wrap is substantially strip-shaped with a greater width than thickness, and substantially conforms to the shape of the chew item as the treat wrap is wrapped around the chew item.

3. The chew item enhancement of claim 2, wherein the treat wrap adheres to itself and the chew item as the treat wrap is wrapped around the chew item.

4. The chew item enhancement of claim 1, wherein the chew item is an ingestible item, and the treat wrap is foldable around the chew item such that the treat wrap adheres to itself to sealably enclose the chew item therein.

5. The chew item enhancement of claim 1, wherein a length of the chew item enhancement is rolled and provided in a dispenser.

6. The system of claim 5, wherein the dispenser includes an opening with a cutting tool, and the chew item enhancement is provided in the dispenser in a rolled fashion such that an end of the chew item enhancement extends into the opening and the rolled chew item enhancement rotates as the end is drawn through the opening to enable the cutting tool to cut the chew item enhancement to a predetermined length.

7. The chew item enhancement of claim 1, wherein a plurality of lengths of the chew item enhancement are stacked and provided in a sealed package.

8. The chew item enhancement of claim 1, wherein the treat wrap includes meat, grains, fruits, vegetables, or any combination thereof.

9. The chew item enhancement of claim 1, wherein the separator is a non-stick or low-stick removable backing.

10. The chew item enhancement of claim 9, wherein the removable backing is formed of plastic, friction reduced paper, or any combination thereof.

11. The chew item enhancement of claim 1, wherein the treat wrap is pliable so as to be reshaped by a user.

12. The chew item enhancement of claim 1, wherein the separator is an individual packet enclosing a predetermined length of the treat wrap.

13. The chew item enhancement of claim 1, wherein the treat wrap is divided into predetermined lengths, and the separator separates the individual lengths when the individual lengths are stacked upon one another.

14. A system to provide a chew item enhancement to animals, the system comprising:
an edible treat wrap having a separator provided to at least one side thereof, the edible treat wrap being formed of a self-adhering material such that when the treat wrap is removed from the separator and the treat wrap is applied to a chew item, the treat wrap adheres to the chew item to encourage the animal to chew the chew item; and
a dispenser to accommodate and dispense the edible treat wrap to a user.

15. The system of claim 14, wherein the chew item is a non-edible plastic or rubberized chew toy.

16. The system of claim 14, wherein the chew item is an edible rawhide bone or toy.

17. The system of claim 14, wherein the dispenser includes an opening with a cutting tool, and the chew item enhancement is provided in the dispenser in a rolled fashion such that an end of the chew item enhancement extends into the opening and the rolled chew item enhancement rotates as the end is drawn through the opening to enable the cutting tool to cut the chew item enhancement to a predetermined length.

18. A method of administering an ingestible item to an animal, the method comprising:
providing an edible treat wrap having a separator on at least one side thereof, the treat wrap being formed of a self-adhering material;
cutting the treat wrap to a predetermined length;
removing the treat wrap from the separator;
placing the ingestible item proximate a first end of the treat wrap;
folding a second end of the treat wrap over the ingestible item to contact the first end;
pressing the first and second ends of the treat wrap together to sealably enclose the ingestible item therein, thus forming a treat wrap-ingestible item combination; and
administering the combination to the mouth of the animal.

19. The method of claim 18, further comprising pressing adjacent sides of the treat wrap together to form a seal at either side of the sealed first and second ends.

20. The method of claim 18, wherein the ingestible item is medicinal or a dietary supplement.

21. The method of claim 19, wherein the ingestible item is one or more of a pill, capsule, gel, paste, liquid, and powder.
